(19) United States
(12) Patent Application Publication
(10) Pub. No.: US 2007/0063023 A1
(43) Pub. Date: Mar. 22, 2007

(54) Device customizing system, device customizing method, authentication agent, recording medium storing device customizing program and computer data signal embodied in carrier wave

(75) Inventor: Koichi Imai, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/522,426

(22) Filed: Sep. 18, 2006

(30) Foreign Application Priority Data
Sep. 22, 2005 (JP) 2005-276033
Aug. 16, 2006 (JP) 2006-221904

(51) Int. Cl. G06K 5/00

(52) U.S. Cl. 235/380

(57) ABSTRACT

A device customizing system which includes: a device having an account information acquisition unit that acquires account information, and a customizing unit that customizes environments and settings of the device based on customize information; an authentication agent including a user data storage unit that stores user data for customizing the device in association with the account information, and a customize information generating unit that acquires the user data from the user data storage unit to generate the customize information; and a directory server including an account information storage unit that stores the account information, and an account information verification unit that verifies the account information acquired by the account information acquisition unit by using the account information storage unit.

### BACKGROUND

1. Technical Field

The present invention relates to a device customizing system, a device customizing method, an authentication agent, a recording medium storing a device customizing program and a computer data signal embodied in a carrier wave. The present invention in particular relates to a device customizing system, a device customizing method, an authentication agent, a recording medium storing a device customizing program and a computer data signal embodied in a carrier wave, which are capable of customizing user interfaces (UIs) or the like of a device depending on the user of the device.

2. Related Art

A device such as a copier or a facsimile, which is used by a plurality of users, stores settings and other information for each of the users within the device so that, when the device is used by a user, the use of the device is supported by extracting the information for the relevant user.

### SUMMARY

An aspect of the present invention relates to a device customizing system which includes: a device including an account information acquisition unit that acquires account information, and a customizing unit that customizes environments and settings of the device based on customize information; an authentication agent including a user data storage unit that stores user data for customizing the device in association with the account information, and a customize information generating unit that acquires the user data from the user data storage unit to generate the customize information; and a directory server including an account information storage unit that stores the account information, and an account information verification unit that verifies the account information acquired by the account information acquisition unit by using the account information storage unit.

### BRIEF DESCRIPTION OF THE DRAWINGS

An exemplary embodiment of the present invention will be described in detail based on the following figures, wherein:

FIG. 1 is a conceptual schematic diagram showing an example of configuration of a device customizing system according to an exemplary embodiment of the present invention, using functional blocks; and

FIG. 2 is a flowchart showing sequential steps of the processing performed by the device customizing system according to the exemplary embodiment of the present invention.

### DETAILED DESCRIPTION

A device customizing system, a device customizing method, an authentication agent, a recording medium storing a device customizing program and a computer data signal embodied in a carrier wave according to an exemplary embodiment will be described with reference to the accompanying drawings.

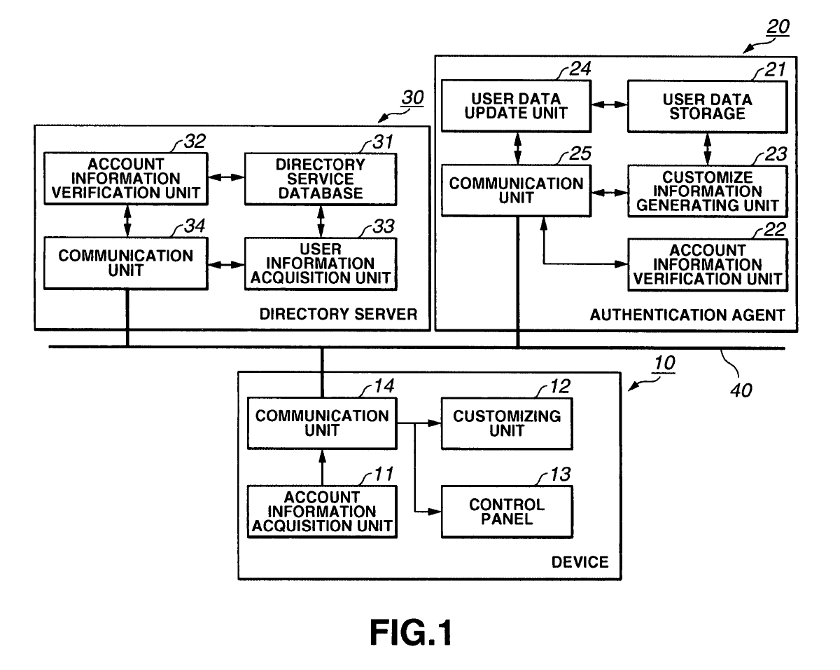

FIG. 1 is a conceptual schematic diagram showing an example of configuration of a device customizing system according to an exemplary embodiment of the present invention, using functional blocks. As shown in FIG. 1, the device customizing system of the present invention includes a device 10 such as a copier or a printer, an authentication agent 20 such as a personal computer (PC) for authenticating a user, and a directory server 30 for providing an active directory (AD) service to manage hardware resources, and attributes and accessibility for each of users or groups. These are connected each other through a wired or wireless network 40 such as a LAN.

The device 10 includes an account information acquisition unit 11 for acquiring account information of a user, a customizing unit 12 for customizing environments and settings for the device, a control panel 13 for receiving operation commands from the user, and a communication unit 14 connected to the authentication agent 20 via the network 40 for exchanging information therewith.

The account information acquisition unit 11 acquires account information, that is information for identifying the user by arbitrary means such as key entry by the user, biometrics, or reading of a non-contact type IC card such as FeliCa.

Upon acquiring account information at the account information acquisition unit 11, the device 10 according to the present embodiment transmits the account information to the authentication agent 20.

Upon receiving customize information and a verification result of the account information from the authentication agent 20, the customizing unit 12 customizes the environments and settings of the device suitably for the user corresponding to the authenticated account information. Any changes in the environments and settings are reflected in the display on the control panel 13. The control panel 13 also displays the verification result of the account information.

The device 10 includes a storage unit such as a RAM (Random Access Memory), a ROM (Read Only Memory) or an HDD (Hard Disk Drive) and a calculation unit such as a CPU (Central Processing Unit), and the account information acquisition unit 11 and the customizing unit 12 are realized by sequentially reading out and processing, by the calculation unit, the program stored in the storage unit.

The authentication agent 20 includes a user data storage 21 for storing user data required for customization of the device, an account information verification unit 22 for transmitting account information to a directory server for performing authentication thereof and transmitting a verification result to the device, a customize information generating unit 23 for generating customize information for each user, a user data update unit 24 for updating user data in the user data storage 21, and a communication unit 25 connected to the device 10 and the directory server 30 via the network 40 for exchanging information therewith.

The user data storage 21 stores user data including, for example, the items as described below.

Actual use record or upper use limit in combination of a service type (copying, printing, scanning, facsimile transmission, or instruction sheet activation) and color mode (monochrome mode or full-color mode), and authority to use service and color mode;

Settings of layout, priority sequence, and selectable values of menu items displayed on the control panel;

Job history;

Address table of individuals or groups (list of facsimile numbers or the like);

Sequence of display in the address table (e.g., sort sequence, or chronological sequence in which the address used most recently is placed at the top);

Information to be included on a transmission sheet (information such as telephone number, facsimile number, company name, and division name to be included on a transmission sheet facsimiled); and

Impairment suffered by the user, if any, and type of impairment.

For example, the device customization is performed based on the user data in a manner as described below:

The user data is used to customize the device by reflecting, in the device, the user data relating to actual use record or upper use limit in combination of a service type and color mode, and authority to use services, color mode, usable paper sheets, and optional functions, and by enabling or restricting the use of certain services or the color mode according to the use authority granted to the user;

The user data relating to settings of menus displayed on the control panel is used in the device customization to reproduce the arrangement of buttons on the control panel set by the user;

The user data relating to job history is used in the device customization to enable the user to confirm the history of jobs performed by the user himself/herself or the group he/she belongs to;

The user data relating to the address table of individuals or groups (list of facsimile numbers or the like) is used in the device customization to enable the user to use abbreviated dialing numbers assigned to the facsimile numbers or the list of facsimile numbers registered;

The user data relating to the sequence of display in the address table is used in the customization to rearrange the addresses in sort sequence or in the chronological sequence in which the address used most recently is placed at the top;

The user data relating to information to be included on transmission sheets is used in the customization to automatically fill the spaces for telephone number, facsimile number, company name, and division name on a facsimile transmission sheet to be facsimiled; and

The user data relating to impairment suffered by the user, if any, and the type of the impairment is used in the customization to provide voice guidance if the user is visually impaired.

The user data and the customization results are not limited to these, but any information can be used as the user data as long as the information is usable to customize the device to obtain desired customization results.

The system may also be designed so that account information is managed for each group of users, namely each division or project team which users belong to, or each title of the users, and the user data for each group of the users is stored as user data applicable to all the account information belonging to the group. In this case, when account information is received from the device, the system determines a group that is associated with the received account information and uses the user data of the relevant group.

The user data stored in the user data storage 21 for each group of users includes, for example, the items as described below:

Actual use record or upper use limit in combination of a service type (copying, printing, scanning, facsimile transmission, or instruction sheet activation) and color mode (monochrome mode or full-color mode), and authority to use services and color mode;

Job history;

Address table of individuals or groups (list of facsimile numbers or the like); and

Information to be included on transmission sheets (information such as telephone number, facsimile number, company name, and division name to be included on a transmission sheet facsimiled).

For example, the device customization is performed based on such user data in a manner as described below:

The user data is used to customize the device by reflecting, in the device, the user data relating to actual use record or upper use limit in combination of a service type and color mode, and authority to use services, color mode, usable paper sheets, and optional functions, and by enabling or restricting the use of certain services or the color mode according to the use authority granted to the user;

The user data relating to job history is used in the device customization to enable the user to confirm the history of jobs performed by the user himself/herself or the group he/she belongs to;

The user data relating to the address table of individuals or groups (list of facsimile numbers or the like) is used in the customization to enable the user to use abbreviated dialing numbers assigned to the facsimile numbers or the list of facsimile numbers registered; and

The user data relating to information to be included on transmission sheets is used in the customization to automatically fill the spaces for telephone number, facsimile number, company name, and division name on a facsimile transmission sheet to be facsimiled.

The user data used for each group of users and the customization performed for each group of users are not limited to these. Any information may be used as user data as long as the information can be used to customize the device in a unified manner as a group and to obtain desired customization result.

If user data stored for each group coexists with user data stored for each user, a priority sequence may be assigned to these two types of user data so that they are applied according to the priority sequence.

For example, in the case when priority is given to the user data stored for each group, the device is customized according to the user data stored for each group when the two types of user data coexist. In other cases, the device is customized according to both the user data stored for each group and the user data stored for each user.

The authentication agent 20 according to the present embodiment first receives account information at the account information verification unit 22, and then transmits the account information to the directory server 30.

Upon receiving a verification result of the account information at the account information verification unit 22, the authentication agent 20 transmits the verification result to the device 10.

Upon receiving user information from the directory server 30, the customize information generating unit 23 generates customize information for customizing the device 10 based on the received user information and the user data stored in the user data storage 21, and the authentication agent 20 transmits the generated customize information to the device 10.

When receiving user data from the device 10, the user data update unit 24 updates the user data stored in the user data storage 21.

The user data received from the device 10 may be transmitted to the directory server 30.

The recognition agent 20 includes a storage unit such as a RAM, a ROM or an HDD and a calculation unit such as a CPU, and the account information verification unit 22, the customize information generating unit 23 and the user data update unit 24 are realized by sequentially reading out and processing, by the calculation unit, the program stored in the storage unit.

The directory server 30 includes a directory service database 31 for storing information such as attributes and accessibility of users to be managed by directory service, in association with account information, an account information verification unit 32 for verifying the account information and transmitting a verification result to the authentication agent 20, a user information acquisition unit 33 for acquiring user information required for customization of the device from the directory service database 31, and a communication unit 34 connected to the authentication agent 20 via the network 40 for exchanging information therewith.

The account information verification unit 32 verifies account information by searching the directory service database 31 for an account that matches the account information received from the authentication agent 20.

The directory server 30 according to the present embodiment first receives account information at the account information verification unit 32 and then verifies the received account information with the use of the directory service database 31.

The user information acquisition unit 33 then acquires user information corresponding to the account information from the directory service database 31, and the directory server 30 transmits the verification result and the user information to the authentication agent 20.

The directory server 30 includes a storage unit such as a RAM, a ROM or an HDD and a calculation unit such as a CPU, and the account information verification unit 32 and the user information acquisition unit 33 are realized by sequentially reading out and processing, by the calculation unit, the program stored in the storage unit.

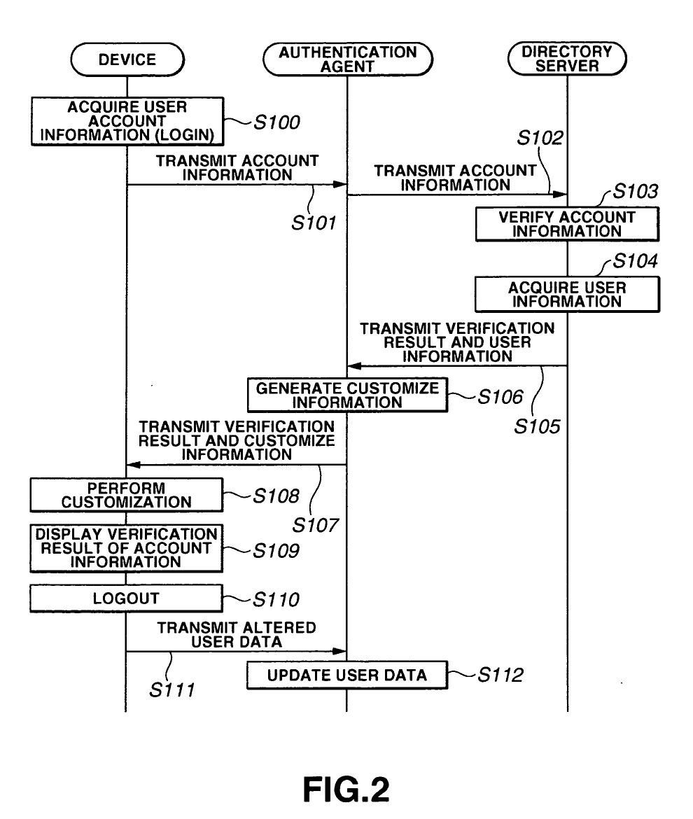

FIG. 2 is a flowchart showing sequential steps of the processing performed by the device customizing system according to the present embodiment.

Firstly, the device acquires account information of the user (step 100), and then transmits the account information to the authentication agent (step 101). The authentication agent transmits the received account information to the directory server (step 102).

The directory server then verifies the account information (step 103). The directory server also acquires user information based on the account information (step 104), and transmits the verification result and the user information to the authentication agent (step 105).

The authentication agent extracts user data required for customization of the device from the user data stored in the user data storage and the user information received from the directory server to generate customize information (step 106). The authentication agent then transmits the verification result of the account information and the customize information to the device (step 107).

The device is customized by updating the environmens and settings based on the customize information (step 108), while the account information verification result is displayed on the control panel (step 109).

When the user logs out (step 110), the device transmits the altered user data to the authentication agent (step 111), and the authentication agent updates the user data (step 112).

In the exemplary embodiment described above, only the authentication agent updates the user data according to the alteration. However, the altered user data may be transmitted from the authentication agent to the directory server so that the user information stored in the directory service database is updated.

The foregoing description of the exemplary embodiment of the present invention has been provided for the purpose of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

What is claimed is:

1. A device customizing system comprising:
a device including an account information acquisition unit that acquires account information, and a customizing unit that customizes environments and settings of the device based on customize information;
an authentication agent including a user data storage unit that stores user data for customizing the device in association with the account information, and a customize information generating unit that acquires the user data from the user data storage unit to generate the customize information; and
a directory server including an account information storage unit that stores the account information, and an account information verification unit that verifies the account information acquired by the account information acquisition unit by using the account information storage unit.

2. The device customizing system according to claim 1, wherein the user data storage unit stores the user data for each group, and the user data are applied to all the account information belonging to each group.

3. The device customizing system according to claim 1, wherein the directory server further comprises a user information acquisition unit that acquires the user information stored in the account information storage unit; and
the customize information generating unit generates the customize information, based on the user data acquired from the user data storage unit and the user information acquired by the user information acquisition unit.

4. The device customizing system according to claim 2, wherein the directory server further comprises a user information acquisition unit that acquires the user information stored in the account information storage unit; and
the customize information generating unit generates the customize information, based on the user data acquired from the user data storage unit and the user information acquired by the user information acquisition unit.

5. A device customizing method comprising:
storing user data for customizing the device in association with account information;
acquiring and verifying the account information;
acquiring the user data associated with the verified account information to generate customize information; and
customizing the device based on the customize information.

6. The device customizing method according to claim 5, wherein the user data are stored for each group, and are applied to all the account information belonging to each group.

7. The device customizing method according to claim 5, wherein the customize information is generated based on the user data acquired from an authentication agent and the user information acquired from a directory server.

8. The device customizing method according to claim 6, wherein the customize information is generated based on the user data acquired from an authentication agent and the user information acquired from a directory server.

9. An authentication agent comprising:
a user data storage unit that stores user data for customizing a device in association with account information; and
a customize information generating unit that, upon receiving a verification result of account information from a directory server, acquires the user data associated with the verified account information from the user data storage unit to generate customize information for customizing the device, and transmits the generated customize information to the device to be customized.

10. The authentication agent according to claim 9, wherein the user data storage unit stores the user data for each group, and the user data are applied to all the account information belonging to each group.

11. The authentication agent according to claim 9, wherein upon receiving the verification result from the directory server, the customize information generating unit generates the customize information based on the user data acquired from the user data storage unit and user information received with the verification result from the directory server.

12. The authentication agent according to claim 10, wherein upon receiving the verification result from the directory server, the customize information generating unit generates the customize information based on the user data acquired from the user data storage unit and user information received with the verification result from the directory server.

13. A computer readable recording medium storing a customizing program causing a computer to execute a process for customizing a device, the process comprising:
storing, in an authentication agent, user data for customizing the device in association with account information;
upon receiving a verification result of account information from a directory server, acquiring the user data associated with the verified account information from the authentication agent to generate customize information for customizing the device; and
transmitting the generated customize information to the device to be customized.

14. The computer readable recording medium according to claim 13, wherein the user data are stored for each group, and are applied to all the account information belonging to each group.

15. The computer readable recording medium according to claim 13, wherein upon receiving the verification result from the directory server, the program causes the computer to execute the process of generating the customize information based on the user data acquired from the authentication agent and user information received with the verification result from the directory server.

16. The computer readable recording medium according to claim 14, wherein upon receiving the verification result from the directory server, the program causes the computer to execute the process of generating the customize information based on the user data acquired from the authentication agent and user information received with the verification result from the directory server.

17. A computer data signal embodied in a carrier wave for enabling a computer to perform a process for customizing a device, the process comprising:
storing, in an authentication agent, user data for customizing the device in association with account information;
upon receiving a verification result of account information from a directory server, acquiring the user data associated with the verified account information from the authentication agent to generate customize information for customizing the device; and
transmitting the generated customize information to the device to be customized.

18. The computer data signal embodied in a carrier wave according to claim 17, wherein the user data are stored for each group, and are applied to all the account information belonging to each group.

19. The computer data signal embodied in a carrier wave according to claim 17, wherein upon receiving the verification result from the directory server, the signal causes the computer to execute the process of generating the customize information based on the user data acquired from the authentication agent and user information received with the verification result from the directory server.

20. The computer data signal embodied in a carrier wave according to claim 18, wherein upon receiving the verification result from the directory server, the signal causes the computer to execute the process of generating the customize information based on the user data acquired from the authentication agent and user information received with the verification result from the directory server.
